(19) United States
(12) Patent Application Publication
(10) Pub. No.: US 2019/0278703 A1
(43) Pub. Date: Sep. 12, 2019

(54) MEMORY SYSTEM, OPERATING METHOD THEREOF AND ELECTRONIC DEVICE

(71) Applicant: SK hynix Inc., Gyeonggi-do (KR)

(72) Inventor: Byung Jun KIM, Gyeonggi-do (KR)

(21) Appl. No.: 16/144,032

(22) Filed: Sep. 27, 2018

(30) Foreign Application Priority Data
Mar. 7, 2018 (KR) 10-2018-0026879

(51) Int. Cl. G06F 12/02; G06F 3/06

(52) U.S. Cl. CPC G06F 12/0246; G06F 2212/7201; G06F 3/0688

(57) ABSTRACT

A memory system may include: a nonvolatile memory device comprising a plurality of blocks; and a controller configured to decide a location at which to store target data corresponding to a write request received from a host device in response to the write request wherein, when a first memory block, of the plurality of memory blocks, to store the target data according to a set sequence satisfies a block replacement condition, the controller sets the first memory block to a closed memory block and controls the nonvolatile memory device to store the target data in a second memory block, of the plurality of memory blocks, set to a new open block.

### CROSS-REFERENCE TO RELATED APPLICATION

The present application claims priority under 35 U.S.C. § 119(a) to Korean application number 10-2018-0026879, filed on Mar. 7, 2018, in the Korean Intellectual Property Office, which is incorporated herein by reference in its entirety.

### BACKGROUND

### 1. Technical Field

Various embodiments generally relate to a memory system and an electronic apparatus, and, more particularly, to a memory system and an electronic apparatus which include a nonvolatile memory device.

### 2. Related Art

A memory system stores the data provided from an external device in response to a write request from the external device. Also, the memory system provides stored data to the external device in response to a read request from the external device. Such an external device may include a computer, a digital camera or a mobile phone. The memory system may be built in the external device, or may be a separate component that is coupled to the external device.

A memory system using a memory device provides advantages in that, since there is no mechanical driving part, stability and durability are excellent, information access speed is fast and power consumption is low. Memory systems having such advantages include a universal serial bus (USB) memory device, memory cards having various interfaces, a universal flash storage (UFS) device, and a solid state drive (SSD).

### SUMMARY

Various embodiments are directed to a memory system capable of performing garbage collection without degradation when data having non-consecutive logical addresses are stored in the same memory block.

In an embodiment, a nonvolatile memory device comprising a plurality of blocks; and a controller configured to decide a location at which to store target data corresponding to a write request received from a host device in response to the write request, wherein, when a first memory block, of the plurality of memory blocks, to store the target data according to a set sequence satisfies a block replacement condition, the controller sets the first memory block to a closed memory block and controls the nonvolatile memory device to store the target data in a second memory block, of the plurality of memory blocks, set to a new open block.

In an embodiment, there is provided an operating method of a memory system which includes a plurality of memory blocks, the operating method comprising: selecting a first memory block, of the plurality of memory blocks, to store target data according to a set sequence in response to a write request received from a host device; determining, by a controller of the memory system, whether the first memory block satisfies a block replacement condition; and setting the first memory block to a closed block, and storing the target data in a second memory block set to a new open block, when the block replacement condition is satisfied, the setting and storing operations being performed by the controller, wherein the block replacement condition comprises a first condition, and the first condition is whether a logical address group corresponding to the most recently stored data in the first memory block and a start logical address corresponding to the target data are consecutive to each other.

In an embodiment, there is provided an electronic device comprising: a controller; and a non-transitory machine-readable storage medium comprising a plurality of memory blocks, and configured to store encoded instructions which are executed by the controller, wherein the instructions comprise: an instruction for specifying a first memory block, of the plurality of memory blocks, having target data stored therein according to a set sequence, when a write request for the target data is received from a host device; an instruction for determining whether the first memory block satisfies a block replacement condition; and an instruction for setting the first memory block to a closed block and controlling a write operation to store the target data in a second memory block set to a new open block, when the first memory block satisfies the block replacement condition.

In an embodiment, there is provided A memory system comprising: a nonvolatile memory device including a plurality of blocks; and a controller configured to receive write data, determine a location at which to store the write data in a first memory block among the plurality of blocks, determine whether the determined location is consecutive to a location at which last data was stored in the first memory block, and when it is determined that the determined location is not consecutive, control the nonvolatile memory device to store the write data in a second memory block among the plurality of blocks.

### BRIEF DESCRIPTION OF THE DRAWINGS

FIG. 1 is a block diagram illustrating a memory system in accordance with an embodiment of the present invention.

FIGS. 2A to 2C illustrate a process in which a plurality of data having non-consecutive logical addresses are stored in the same memory block.

FIGS. 3A to 3C illustrate a process in which a plurality of data having non-consecutive logical addresses are stored in different memory blocks in accordance with an embodiment of the present invention.

FIGS. 4A to 4C illustrate a process in which data are stored in a memory block, based on the consecutiveness of logical addresses and the number of pages having no data stored therein, in accordance with an embodiment of the present invention.

FIGS. 5A to 5C illustrate a process in which data are stored in a memory block, based on the consecutiveness of logical addresses, the number of pages having no data stored therein and the number of memory blocks having no data stored therein, in accordance with an embodiment of the present invention.

FIG. 6 illustrates an example in which garbage collection is performed after data having non-consecutive logical addresses are stored in the same memory block.

FIG. 7 illustrates an example in which garbage collection is performed after data having non-consecutive logical addresses are stored in different memory blocks, in accordance with an embodiment of the present invention.

FIG. 8 is a block diagram illustrating a controller in accordance with an embodiment of the present invention.

FIG. 9 illustrates a data processing system including a solid state drive (SSD) in accordance with an embodiment of the present invention.

FIG. 10 illustrates a data processing system including a memory system in accordance with an embodiment of the present invention.

FIG. 11 illustrates a data processing system including a memory system in accordance with an embodiment of the present invention.

FIG. 12 illustrates a network system including a memory system in accordance with an embodiment of the present invention.

FIG. 13 is a block diagram illustrating a nonvolatile memory device included in a memory system in accordance with an embodiment of the present invention.

### DETAILED DESCRIPTION

In the present invention, advantages, features and methods for achieving them will become more apparent from the following embodiments described in conjunction with the drawings. The present invention may, however, be embodied in different forms and thus is not limited to the embodiments set forth herein. Rather, these embodiments are provided to describe the present invention in detail to the extent that a person skilled in the art to which the invention pertains can easily practice the present invention. Also, throughout the specification, reference to “an embodiment,” “another embodiment,” or the like is not necessarily to only one embodiment, and different references to any such phrase are not necessarily to the same embodiment(s).

It is to be understood herein that embodiments of the present invention are not limited to the particulars shown in the drawings and that the drawings are not necessarily to scale, and in some instances proportions may be exaggerated in order to more clearly depict certain features of the invention. While particular terminology is used herein, it is to be appreciated that the terminology used herein is for the purpose of describing particular embodiments and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms and vice versa, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

A memory system, an operating method thereof and an electronic apparatus will be described below with reference to the accompanying drawings through various embodiments.

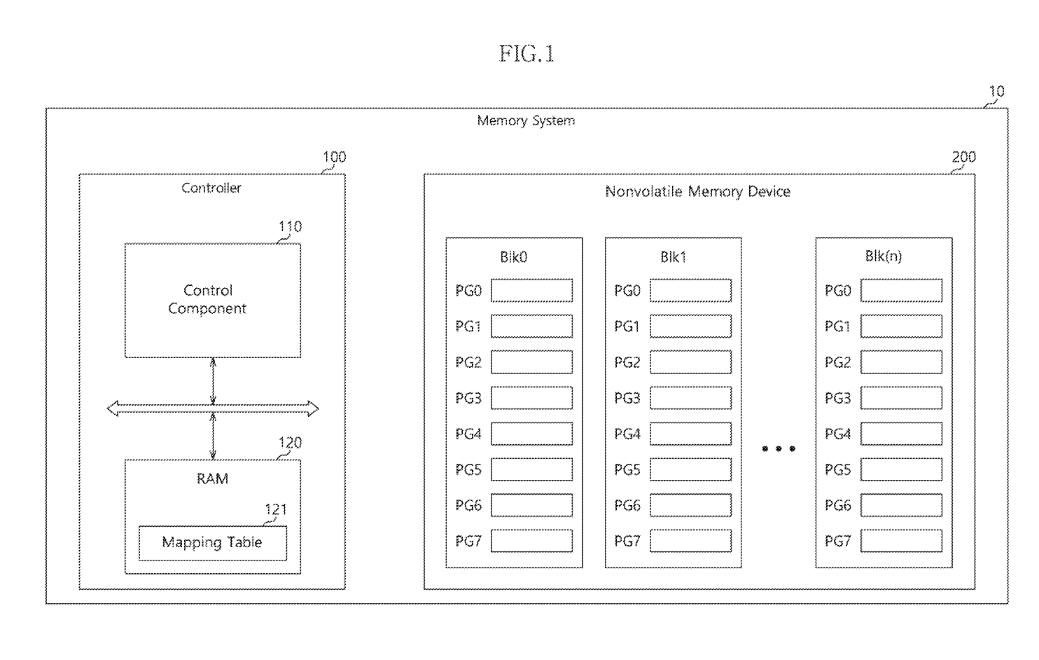

FIG. 1 is a block diagram illustrating a memory system 0 in accordance with an embodiment of the present invention.

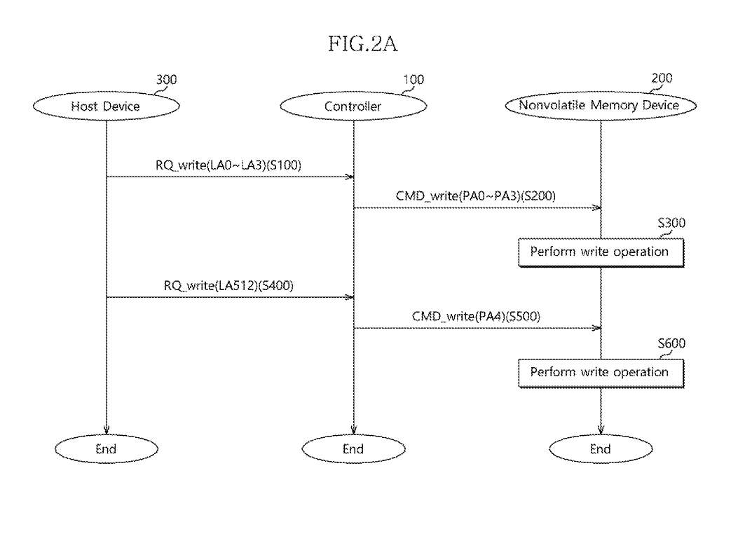

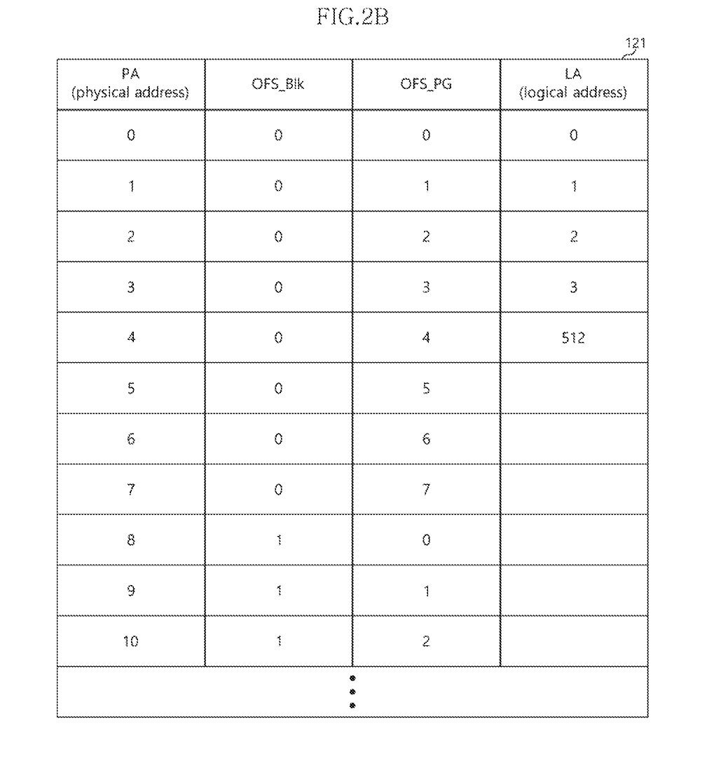

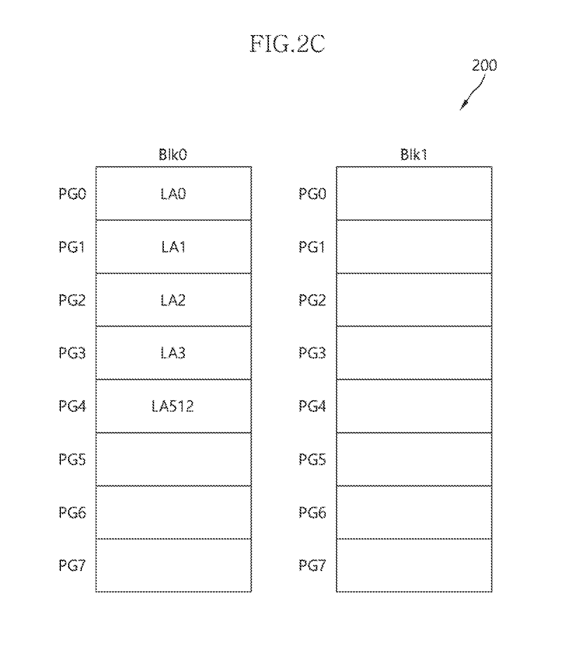

Referring to FIG. 1, the memory system 10 may store data to be accessed by a host device (e.g., host device 300 of FIG. 2A) such as a mobile phone, an MP3 player, a laptop computer, a desktop computer, a game player, a television (TV), an in-vehicle infotainment system, and the like.

The memory system 10 may be any one of various kinds of storage devices according to a host interface, which is a transmission protocol with the host device 300. For example, the memory system 100 may be configured as any one of various kinds of storage devices such as a solid state drive (SSD), a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component interconnection (PCI) card type storage device, a PCI express (PCI-e or PCIe) card type storage device, a compact flash (CF) card, a smart media card, a memory stick, and so forth.

The memory system 10 may be any one among various kinds of package types such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The memory system 10 may include a controller 100 and a nonvolatile memory device 200. The controller 100 may include a control component 110 and a random access memory (RAM) 120.

The control component 110 may be constructed of circuits to form a micro control unit (MCU) or a central processing unit (CPU). The control component 110 may process a request which is received from the host device 300. In order to process the request, the control component 110 may drive an instruction or algorithm of a code type, that is, a firmware (FW), loaded in the RAM 120, and may control internal function blocks and the nonvolatile memory device 200.

The RAM 120 may include a dynamic RAM (DRAM) or static RAM (SRAM). The RAM 120 may store firmware FW driven by the control component 110. Furthermore, the RAM 120 may store data required for driving the firmware FW, for example, meta data. That is, the RAM 120 may operate as a working memory of the control component 110.

The RAM 120 may store a mapping table 121 including mapping information between logical addresses and physical addresses. The control unit 110 may manage a logical-to-physical (L2P) mapping table and a physical-to-logical (P2L) mapping table. The L2P mapping table may include physical addresses mapped to logical addresses set to indexes. The P2L mapping table may include logical addresses mapped to physical addresses set to indexes. The control component 110 may manage mapping information on an open memory block as the P2L mapping table. The open memory block indicates a memory block which is being used to process a write request. The control component 110 may reflect mapping information forming the P2L mapping table for closed memory blocks (i.e., memory blocks having no empty spaces for storing data or configured not to store data), into the L2P table.

The nonvolatile memory device 200 may be implemented with any one of various nonvolatile memory devices including a NAND flash memory device, a NOR flash memory device, a ferroelectric random access memory (FRAM) using a ferroelectric capacitor, a magnetic random access memory (MRAM) using a tunneling magneto-resistive (TMR) film, a phase change random access memory (PRAM) using chalcogenide alloys, and a resistive random access memory (ReRAM) using a transition metal oxide.

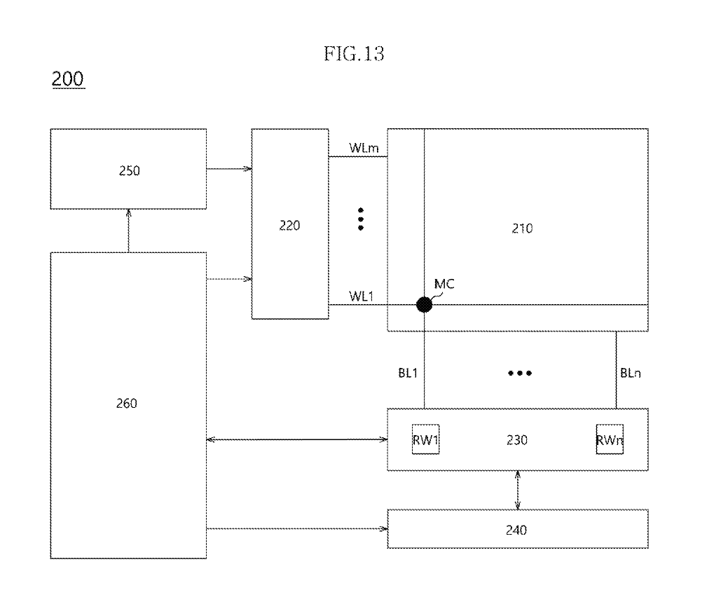

The nonvolatile memory device 200 may include a memory cell array (e.g., memory cell array 210 of FIG. 13). Memory cells included in the memory cell array may be configured on a basis of hierarchical memory cell group or memory cell, from the operational viewpoint or physical (or structural) viewpoint. For example, memory cells which are coupled to the same word line and read and/or written (or programmed) at the same time may be configured as a page, Memory cells configured as a page may be referred to as “page”, Furthermore, memory cells which are erased at the same time may be configured as a memory block. The memory cell array may include a plurality of memory blocks Blk0 to Blk(n). Each of the memory blocks Blk0 to Blk(n) may include a plurality of pages (for example, pages PG0 to PG7).

The control component 110 may select an open block as a memory block to store data, among free blocks having no data stored therein. For example, the control component 110 may set the block Blk0 to the open block when all of the blocks Blk0 to Blk(n) are free blocks. Then, the control unit 110 may control the nonvolatile memory device 200 to store write data in the block Blk0 set to the open block. The write data corresponds to a write request from the host device 300. The control component 110 may set an open memory block to a closed block in which data will not be stored any more. For example, the control component 110 may change the block Blk0 set to the open block to a closed block. Then, no data will be stored in the block Blk0. The control component 110 may set a new free block to an open block after setting the open block to the closed memory block. In an embodiment, the open block may be set on a memory block basis. In another embodiment, an open block may be set on a super block basis by which memory blocks sharing the same word line are grouped. However, the basis for setting an open block may be set and changed according to control of the control component 110 or the host device 300.

FIGS. 2A to 2C illustrate a process in which a plurality of data having non-consecutive logical addresses are stored in the same memory block. Referring to FIGS. 1 and 2A to 2C, a process in which data having non-consecutive logical addresses are stored in the nonvolatile memory device 200 is described. For the purpose of such description, the nonvolatile memory device 200 includes the memory blocks Blk0 and Blk1, and each of the memory blocks Blk0 and Blk1 includes eight pages PG0 to PG7.

At step S100, the controller 100 may receive write requests RQ_write (LA0 to LA3) for data corresponding to logical addresses LA0 to LA3 from the host device 300. After receiving the write requests RQ_write (LA0 to LA3), the controller 100 may check an open block to store data, by referring to the mapping table 121 stored in the RAM 120. Here, the memory block Blk0 is set to an open block, and no data are stored in the pages PG0 to PG7 in the memory block Blk0.

The controller 100 may generate commands CMD_write (PA0 to PA3) to transfer to the nonvolatile memory device 200, in response to the write requests RQ_write (LA0 to LA3) received from the host device 300. Further, the controller 100 may decide information on a memory block and page to store data, by referring to the mapping table 121. As illustrated in FIG. 2A, the controller 100 may generate the commands CMD_write (PA0 to PA3) including address information of the pages PG0 to PG3 of the memory block Blk0 set to an open block. As illustrated in FIG. 2B, the mapping table 121 may store block offsets OFS_Blk and page offsets OFS_PG corresponding to physical addresses, respectively. For example, a physical address PA4 may correspond to a page with a page offset OFS_PG of 4, among pages included in a memory block with a block offset OFS_Blk of 0. A physical address PA9 may correspond to a page having a page offset OFS_PG of 1, among pages included in a memory block having a block offset OFS_Blk of 1.

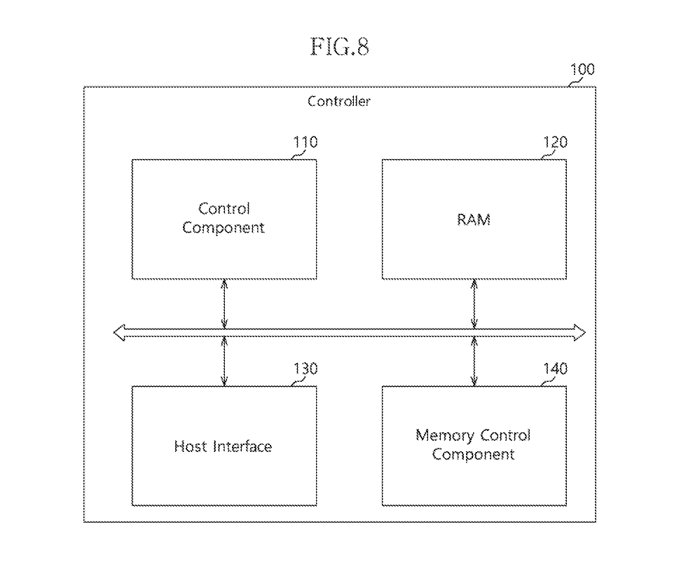

At step S200, the controller 100 may transfer the generated commands CMD_write (PA0 to PA3) to the nonvolatile memory device 200. The process in which the controller 100 interfaces the host device 300 and the nonvolatile memory device 200 will be described below with reference to FIG. 8.

At step S300, the nonvolatile memory device 200 may perform a write operation for data corresponding to logical address LA0 to LA3 in response to the commands CMD_write (PA0 to PA3) outputted from the controller 100. Specifically, the data may be stored in areas corresponding to physical addresses PA0 to PA3. That is, the data may be stored in pages coupled to a word line having page offsets OFS_PG of 0 to 3, among pages included in a memory block having a block offset OFS_Blk of 0.

After the data are stored, the mapping table 121 including the physical addresses of the memory block having the data stored therein may be updated. FIG. 2B shows that the storing of the data corresponding to the logical addresses LA0 to LA3 is marked on the mapping table 121 corresponding to the physical addresses PA0 to PA3, The mapping table 121 may be updated at a particular time, which may be set in advance and changed.

After the data are stored in the areas of the nonvolatile memory device 200, corresponding to the physical addresses PA0 to PA3, the controller 100 may receive a write request RQ_write (LA512) for data corresponding to a logical address LA512 from the host device 300 at step S400. The controller 100 may check an open block to store data, by referring to the mapping table 121 stored in the RAM 120, and determine that an area corresponding to a physical address PA4, i.e., an area having a block offset OFS_Blk of 0 and a page offset OFS_PG of 4 is an area to store data according to a set or preset sequence.

Then, the controller 100 may generate a command CMD_write (PA4) to transfer to the nonvolatile memory device 200. The command CMD_write (PA4) may include information on the physical address PA4 indicating the physical address of the area to store data. At step S500, the controller 100 may transfer the generated command CMD_write (PA4) to the nonvolatile memory device 200. At step S600, the nonvolatile memory device 200 may perform a write operation for data corresponding to the command CMD_write (PA4). Specifically, the data may be stored in the area corresponding to the physical address PA4, i.e., a page corresponding to the block offset OFS_Blk of 0 and the page offset OFS_PG of 4.

When the write operations for the data corresponding to the logical addresses LA0 to LA3 and the logical address LA512 are performed, the data may be stored in the pages PG0 to PG4 included in the memory block Blk0. Then, the mapping table 121 may be updated by reflecting the storage of the data.

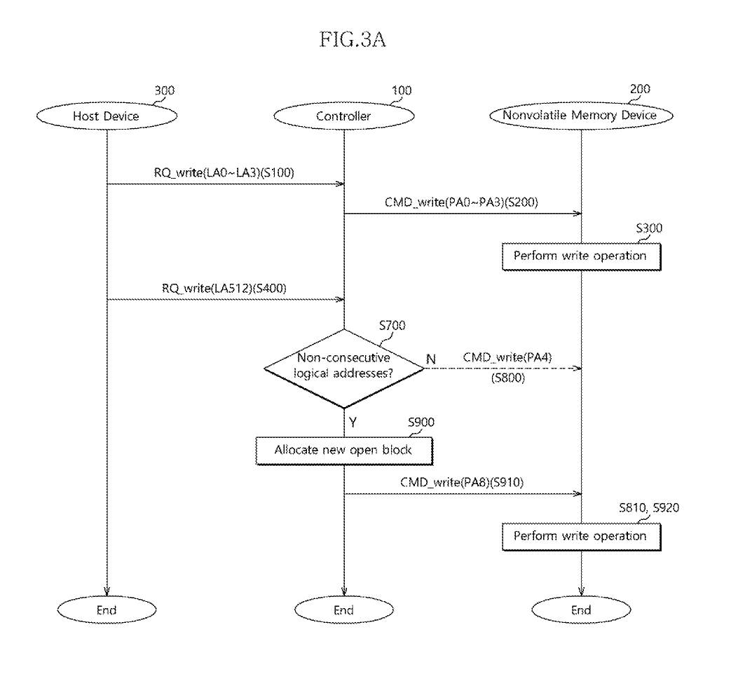

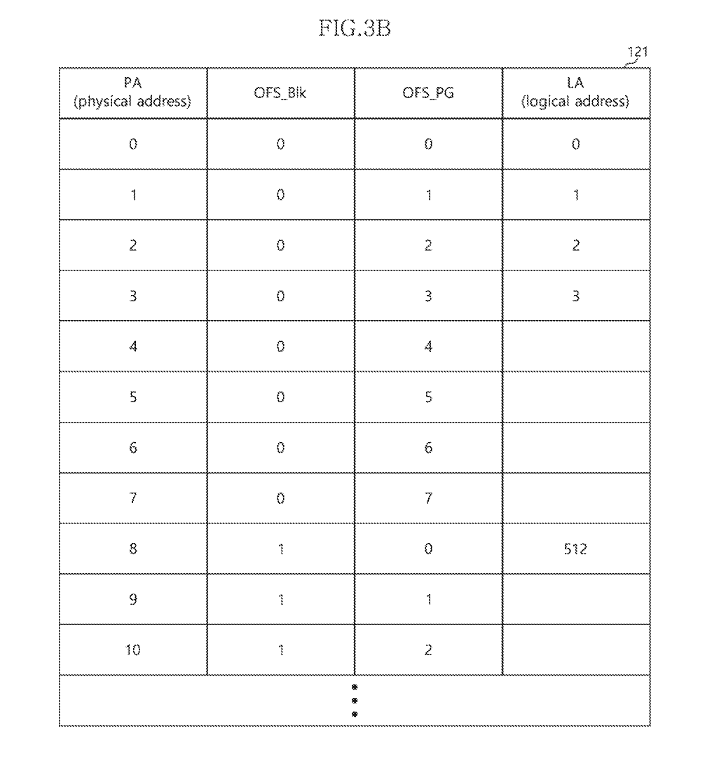

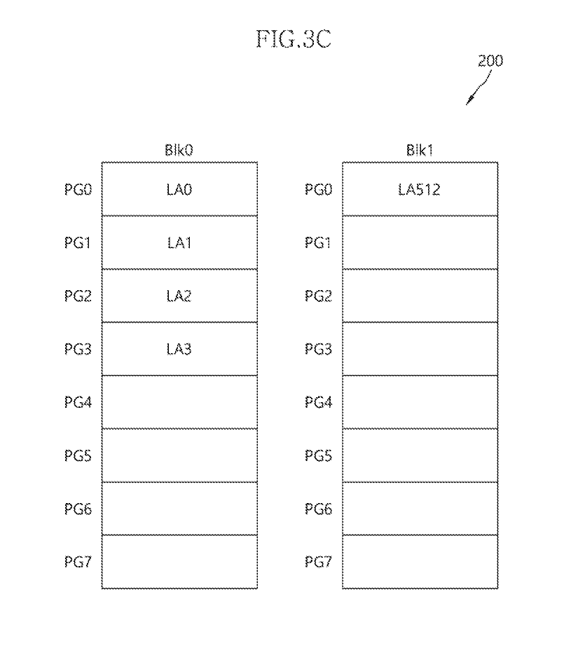

FIGS. 3A to 3C illustrate a process in which a plurality of data having non-consecutive logical addresses are stored in different memory blocks, in accordance with an embodiment of the present invention. Steps S100 to S400 of FIG. 2A are performed in the same manner. That is, after data are stored in the areas corresponding to the physical addresses PA0 to PA3 in response to the write requests RQ_write (LA0 to LA3) from the host device 300, as shown in FIG. 3C, the write request RQ_write (LA512) corresponding to the logical address LA512 may be received from the host device 300. For purpose of this description, the nonvolatile memory device 200 includes the memory blocks Blk0 and Blk1, and each of the memory blocks Blk0 and Blk1 includes eight pages PG0 to PG7.

The memory system 10 may include the nonvolatile memory device 200 including a plurality of memory blocks and the control component 110 which decides a position to store target data corresponding to a write request received from the host device 300, in response to the write request. When a first memory block to store the target data according to a set or preset sequence satisfies a block replacement condition, the control component 110 may set the first memory block to a closed block, and control the nonvolatile memory device 200 to store the target data in a second memory block set to a new open block. In various embodiments, the block replacement condition may include a first condition which is satisfied when a logical address group corresponding to the most recently stored data in the first memory block and a start logical address corresponding to the target data are not consecutive to each other.

At step S700, the controller 100 may determine whether the logical address LA512 as the start logical address corresponding to the target data and the logical address group corresponding to the most recently stored data are not consecutive to each other. As illustrated in FIG. 3A, the logical address group corresponding to the most recently stored data may include logical addresses LA0 to LA3, and the controller 100 may determine whether the logical address LA3 and the logical address LA512 are not consecutive to each other.

In an embodiment, when it is determined that the logical address group corresponding to the most recently stored data and the start logical address corresponding to the target data are consecutive to each other (NO at step S700), at step S800 the controller 100 may generate a command CMD_write (PA4) including information on a physical address PA4 corresponding to an area to store data according to a set or preset sequence, and transfer the generated command to the nonvolatile memory device 200. The physical address PA4 may include information on a page corresponding to a block offset OFS_Blk of 0 and a page offset OFS_PG of 4. Then, at step S810, a write operation corresponding to the command CMD_write (PA4) may be performed in the nonvolatile memory device 200. Specifically, data may be stored in the page PG4 of the memory block Blk0 set to an open block (e.g., memory block Blk0 in FIG. 3C).

When it is determined that the logical address group corresponding to the most recently stored data and the start logical iG address corresponding to the target data are not consecutive to each other or the first condition is satisfied (YES at step S700), at step S900 the controller 100 may allocate the memory block Blk1 as a new open block, and set the memory block Blk0 to a closed block (e.g., memory blocks Blk0 and Blk1 in FIG. 3C).

At step S910, the controller 100 may generate a write command CMD_write (PA8) for the target data, and transfer the generated write command CMD_write (PA8) to the nonvolatile memory device 200. The write command CMD_write (PA8) includes a physical address PA8 corresponding to a page to store data among the pages of the second memory block set to a new open block, i.e., the memory block Blk1. As illustrated in FIG. 3B, the physical address PA8 may indicate a page corresponding to a block offset OFS_Blk of 1 and a page offset OFS_PG of 0.

At step S920, the target data corresponding to the logical address LA512 may be stored in an area corresponding to the physical address PA8 of the nonvolatile memory device 200, i.e., the page corresponding to the block offset OFS_Blk of 1 and the page offset OFS_PG of 0.

As a result, the data corresponding to the logical addresses LA0 to LA3 may be stored in the pages corresponding to the physical addresses PA0 to PA3 in the memory block Blk0, and the memory block Blk0 may be set to a closed block, with no data stored in the pages corresponding to the physical addresses PA4 to PA7, i.e., the pages PG4 to PG7 corresponding to the page offsets OFS_PG of 4 to 7 among the pages PG0 to PG7 included in the block offset OFS_Blk of 0.

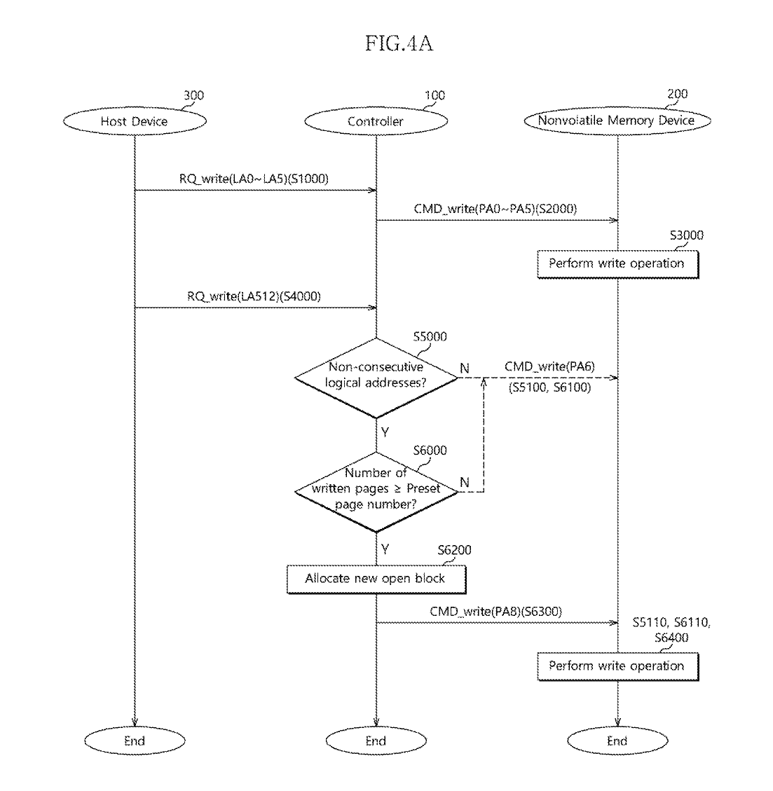

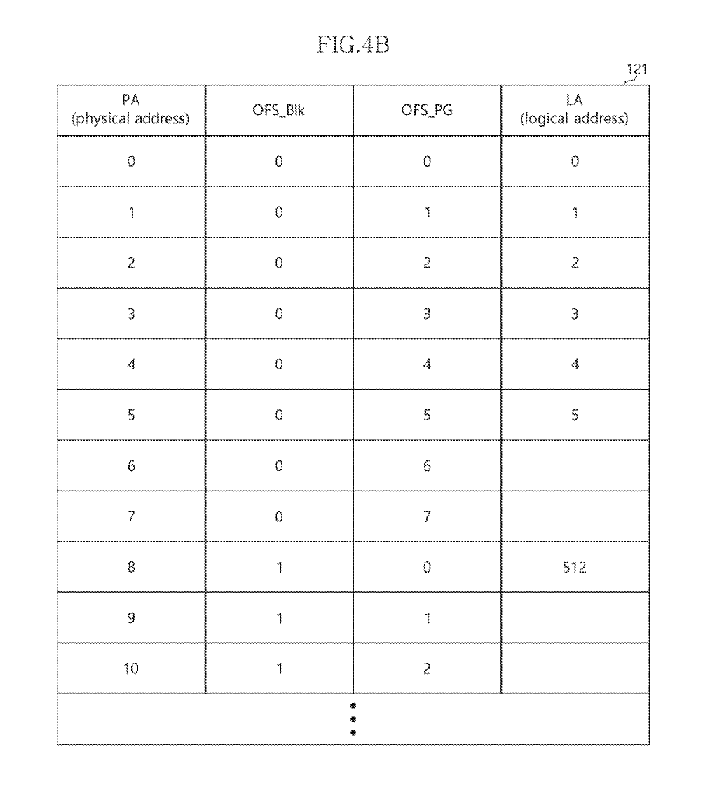

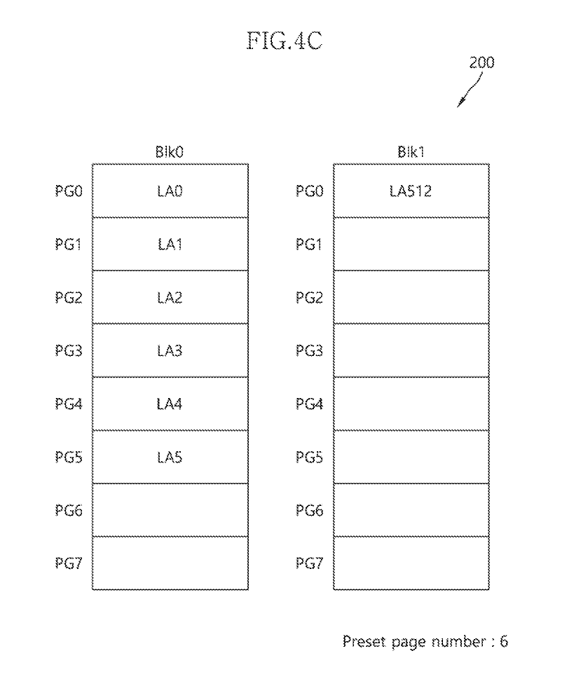

FIGS. 4A to 4C illustrate a process in which data are stored in a memory block (e.g., a second memory block Blk1 of FIG. 4C) based on the consecutiveness of logical addresses and the number of pages having no data stored therein, in accordance with an embodiment of the present invention. For the purpose of such description, the nonvolatile memory device 200 includes the memory blocks Blk0 and Blk1, and each of the memory blocks Blk0 and Blk1 includes eight pages PG0 to PG7. A process in which data are stored in a new open block based on the consecutiveness of logical addresses and the number of pages having no data stored therein will be described with reference to FIGS. 1 and 4A to 4C.

At step S1000, the controller 100 may receive write requests RQ_write (LA0 to LA5) for data corresponding to logical addresses LA0 to LA5 from the host device 300. After receiving the write requests RQ_write (LA0 to LA5), the controller 100 may check an open block to store data, by referring to the mapping table 121 stored in the RAM 120. Here, the memory block Blk0 is set to an open block, and no data are stored in the pages PG0 to PG7 included in the memory block Blk0.

At step S2000, the controller 100 may generate commands CMD_write (PA0 to PA5) to transfer to the nonvolatile memory device 200, in response to the requests RQ_write (LA0 to LA5) received from the host device 300, and transfer the generated commands CMD_write (PA0 to PA5) to the nonvolatile memory device 200. Further, the controller 100 may decide information on a memory block and page to store data, by referring to the mapping table 121. As illustrated in FIG. 4A, the controller 100 may generate the commands CMD_write (PA0 to PA5) including address information of the pages PG0 to PG5 of the memory block Blk0 set to the open block, i.e., physical addresses PA0 to PA5.

At step S3000, the nonvolatile memory device 200 may perform a write operation for data corresponding to the logical address LA0 to LA5 based on the commands CMD_write (PA0 to PA5) received from the controller 100. Specifically, the data may be stored in areas corresponding to the physical addresses PA0 to PA5. That is, the data may be stored in the pages PG0 to PG5 coupled to a word line having page offsets OFS_PG of 0 to 5 among the pages PG0 to PG7 included in the memory block Blk0 having a block offset OFS_Blk of 0.

After the data are stored, the mapping table 121 including the physical addresses of the memory block having the data stored therein may be updated. FIG. 4B shows that the storing of the data corresponding to the logical addresses LA0 to LA5 is marked in the mapping table 121 corresponding to the physical addresses PA0 to PA5. The mapping table 121 may be updated at a particular time, which may be set in advance and changed.

At step S4000, the controller 100 may receive a write request RQ_write (LA512) for data corresponding to a logical address LA512 from the host device 300. The controller 100 may check an open block to store data, by referring to the mapping table 121 stored in the RAM 120. Then, the controller 100 may determine that an area corresponding to the physical address PA6, i.e., an area having a block offset OFS_Blk of 0 and a page offset OFS_PG of 6 is the area to store data, according to the set or preset sequence.

The memory system 10 may include the nonvolatile memory device 200 including the plurality of memory blocks and the control component 110 configured to decide a location at which to store target data corresponding to a write request received from the host device 300, in response to the write request. When the first memory block to store the target data according to a set or preset sequence satisfies a block replacement condition, the control component 110 may set the first memory block to a closed block and control the nonvolatile memory device 200 to store the target data in a second memory block set to a new open block. In various embodiments, the block replacement condition may include a first condition which is satisfied when a logical address group corresponding to the most recently stored data and a start logical address corresponding to the target data are not consecutive to each other. In an embodiment, the block replacement condition may include the first and second conditions. The second condition is satisfied when the number of pages having data stored therein among the pages in the first memory block is greater than or equal to a particular or preset page number. In an embodiment, when the first and second conditions are satisfied, the control component 110 may control the nonvolatile memory device 200 to store the target data in the second memory block. When one or more of the first and second conditions are not satisfied, the control component 110 may control the nonvolatile memory device 200 to store the target data in the first memory block. The above-described process will be described in detail with reference to steps S5000 to S6400.

At step S5000, the controller 100 may determine whether the target data satisfy the first condition. As illustrated in FIG. 4A, the controller 100 may determine whether the logical address LA512 as the start logical address corresponding to the target data and the logical address group corresponding to the most recently stored data are not consecutive to each other. The logical address group corresponding to the most recently stored data may include the logical addresses LA0 to LA5. The control unit 110 may determine whether the logical address LA5 and the logical address LA512 as the start logical address are not consecutive to each other.

In an embodiment, when it is determined that the logical address group corresponding to the most recently stored data and the start logical address corresponding to the target data are consecutive to each other (No at step S5000), at step S5100 the controller 100 may generate a command CMD_write (PA6) including information on a physical address PA6 corresponding to an area to store data according to a set or preset sequence, and transfer the generated command to the nonvolatile memory device 200. The physical address PA6 may include information on a page corresponding to a block offset OFS_Blk of 0 and a page offset OFS_PG of 6. Then, at step S5110, a write operation corresponding to the command CMD_write (PA6) may be performed in the nonvolatile memory device 200. Specifically, data may be stored in the page PG6 of the memory block Blk0 (e.g., memory block Blk0 in FIG. 4C).

In another embodiment, when it is determined that the logical address corresponding to the most recently stored data and the start logical address corresponding to the target data are not consecutive to each other (YES at step S5000), at step S6000 the controller 100 may determine whether the second condition is satisfied. Specifically, the controller 100 may determine whether the number of pages having data stored therein, among the pages PG0 to PG7 included in the first memory block set to an open block, i.e., the memory block Blk0 is greater than or equal to a particular or preset page number. In FIGS. 4A to 4C, the particular or preset page number is 6. The controller 100 may determine how many pages have data stored therein, among the pages in the memory block Blk0 which is an open block to store data according to the set or preset sequence. The controller 100 may determine that data are stored in the pages having page offsets OFS_PG of 0 to 5, i.e., the pages PG0 to PG5 among the eight pages PG0 to PG7 in the memory block Blk0. Since the number of pages having data stored therein is greater than or equal to the particular or preset page number, the controller 100 may determine that the second condition is satisfied. In an embodiment, the particular or preset page number may be set or changed by the host device 300 or the control component 110.

In an embodiment, when the first and second conditions are satisfied, the controller 100 may determine a memory block to store data corresponding to non-consecutive logical addresses. In other words, based on the amount of data stored in the open block which is to store data according to the set or preset sequence, the controller 100 may decide a memory block to store data corresponding to non-consecutive logical addresses. Further, the control component 110 may decide whether to set the open block to a closed block, depending on the amount of data stored in the corresponding open block, and thus use the storage space more efficiently.

In another embodiment, when it is determined that the second condition is not satisfied, that is, when the number of pages having data stored therein among the pages in the first memory block is less than the particular or preset page number (NO at step S6000), at step S6100 the controller 100 may generate the command CMD_write (PA6) including information on the physical address PA6 corresponding to the area to store data according to the set or preset sequence, and transfer the generated command to the nonvolatile memory device 200. The physical address PA6 may include information on the page corresponding to the block offset OFS_Blk of 0 and the page offset OFS_PG of 6. Then, at step S6110, a write operation corresponding to the command CMD_write (PA6) may be performed in the nonvolatile memory device 200. Specifically, data may be stored in the page PG6 of the memory block Blk0.

In an embodiment, when it is determined that the first and second conditions are satisfied (YES at steps S5000 and S6000), at step S6200 the controller 100 may allocate the second memory block, i.e., the memory block Blk1 as a new open block, and set the memory block Blk0 to a closed block (e.g., Blk0 and Blk1 in FIG. 4C). Then, at step S6300, the controller 100 may generate a write command CMD_write (PA8) for the target data and transfer the generated write command CMD_write (PA8) to the nonvolatile memory device 200. The write command CMD_write (PA8) includes a physical address PA8 corresponding to a page to store data among the pages PG0 to PG7 of the second memory block set to the new open block, i.e., the memory block Blk1. At step S6400, the target data corresponding to the logical address LA512 may be stored in an area corresponding to the physical address PA8 of the nonvolatile memory device 200, i.e., a page corresponding to a block offset OFS_Blk of 1 and a page offset OFS_PG of 0.

As a result, the data corresponding to the logical addresses LA0 to LA5 may be stored in the pages corresponding to the physical addresses PA0 to PA5 in the memory block Blk0, and the pages corresponding to the physical addresses PA6 and PA7, i.e., the pages of the memory block Blk0 corresponding to the page offsets OFS_PG of 6 and 7 may be set to a closed block with no data stored therein.

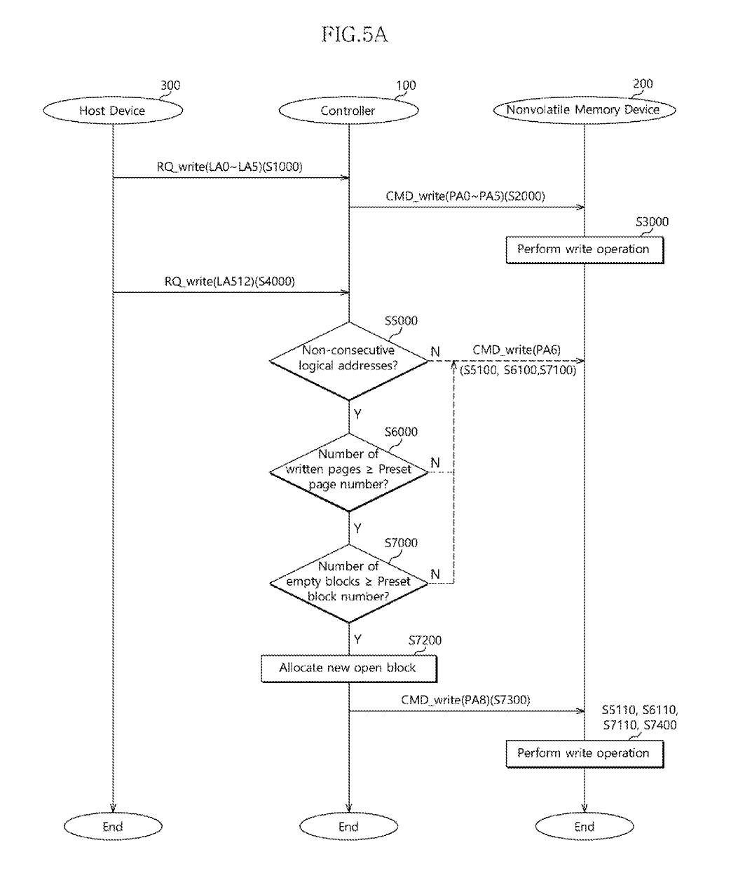

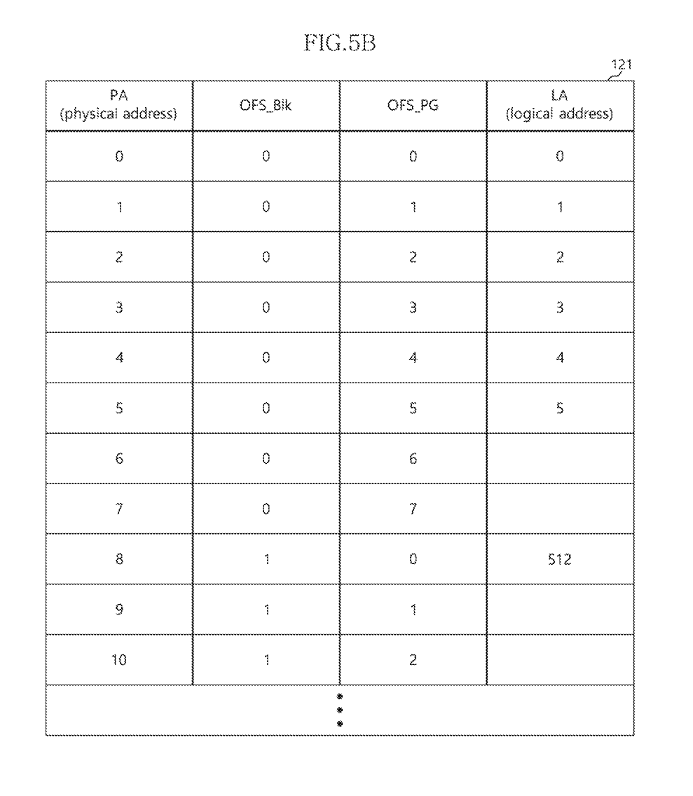

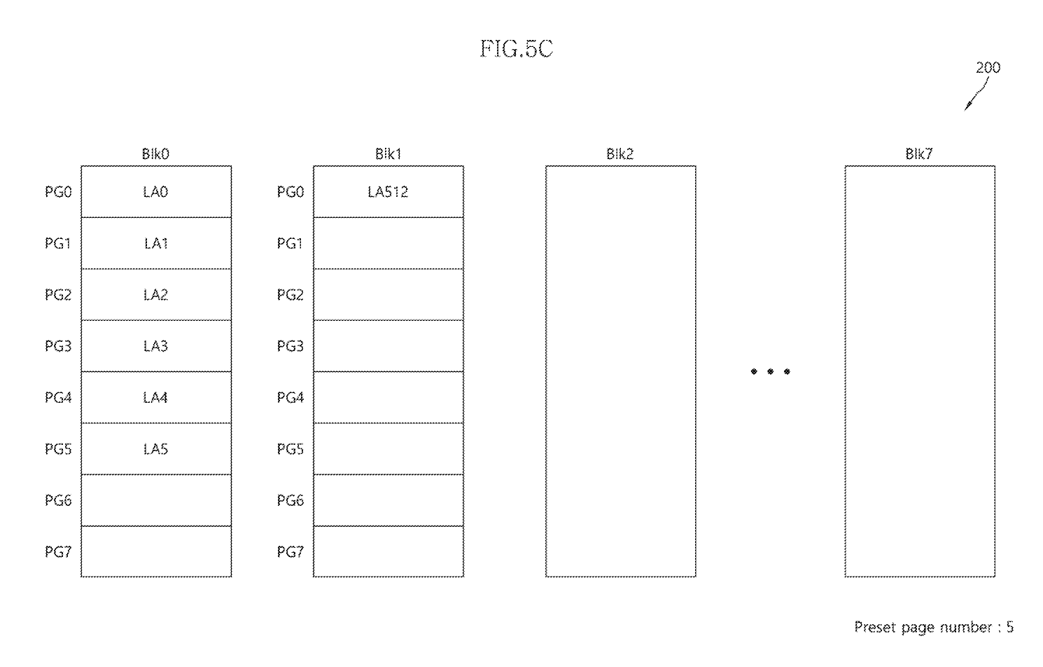

FIGS. 5A to 5C illustrate a process in which data are stored in a memory block (e.g., the second memory block Blk1 of FIG. 5C) based on the consecutiveness of logical addresses, the number of pages having no data stored therein and the number of blocks having no data stored therein, in accordance with an embodiment of the present invention. Here, the nonvolatile memory device 200 includes eight memory blocks Blk0 to Blk7, and each of the memory blocks Blk0 to Blk7 includes eight pages PG0 to PG7. A process in which data are stored in a new open block based on the consecutiveness of logical addresses, the number of pages having no data stored therein and the number of memory blocks having no data stored therein will be described with reference to FIGS. 1 and 5A to 5C. Furthermore, steps S1000 to S6110 described with reference to FIGS. 4A to 4C are applied in the same manner when FIGS. 5A to 5C are described.

The memory system 10 may include the nonvolatile memory device 200 including a plurality of memory blocks and the control component 110 configured to decide a location at which to store target data corresponding to a write request received from the host device 300, in response to the write request. The control unit 110 may set a first memory block to a closed block when the first memory block to store data according to a set or preset sequence satisfies a block replacement condition, and control the nonvolatile memory device 200 to store the target data in a second memory block set to a new open block. In various embodiments, the block replacement condition may include a first condition which is satisfied when a logical address group corresponding to the most recently stored data in the first memory block and a start logical address corresponding to the target data are not consecutive to each other. In an embodiment, the block replacement condition may include the first to third conditions. The second condition may indicate a condition that is satisfied when the number of pages having data stored therein among the pages included in the first memory block is greater than or equal to a particular or preset page number. The third condition is satisfied when the number of memory blocks having no data stored therein among the memory blocks is greater than or equal to a set or preset block number. In an embodiment, when the first to third conditions are satisfied, the control component 110 may control the nonvolatile memory device 200 to store the target data in the second memory block. When one or more of the first to third conditions are not satisfied, the control component 110 may control the nonvolatile memory device 200 to store the target data in the first memory block. In another embodiment, when the first and third conditions are satisfied, the control component 110 may control the nonvolatile memory device 200 to store the target data in the second memory block. When the first or third condition is not satisfied, the control component 110 may control the nonvolatile memory device 200 to store the target data in the first memory block.

In an embodiment, when it is determined that the first and second conditions are satisfied (YES at steps S5000 and S6000), at step S7000 the controller 100 may determine whether the third condition is satisfied. In other words, the controller 100 may determine whether the number of memory blocks having no data stored therein, among the memory blocks Blk0 to Blk7 in the nonvolatile memory device 200, is greater than or equal to the set or preset block number.

In an embodiment, when the first to third conditions are satisfied (YES at steps S5000, S6000 and S7000), the controller 100 may decide a memory block to store data corresponding to non-consecutive logical addresses. In other words, based on the amount (or ratio) of data stored in the open block and the number of free blocks, the controller 100 may decide a memory block to store data corresponding to non-consecutive logical addresses. In this case, the controller 100 may decide whether to set the corresponding open block to a closed block, depending on the amount of data stored in the open block and the number of free blocks having no data stored therein, and thus use the storage space more efficiently.

When it is determined that the third condition is not satisfied (NO at step S7000), i.e., the number of memory blocks having data stored therein among the memory blocks Blk0 to Blk7 is less than the set or preset block number, at step S7100, the controller 100 may generate the command CMD_write (PA6) including information on the physical address PA6 corresponding to the area which is to store data according to the set or preset sequence, and transfer the generated command to the nonvolatile memory device 200. The physical address PA6 may include information on the page corresponding to the block offset OFS_Blk of 0 and the page offset OFS_PG of 6. Then, at step S7110, a write operation corresponding to the command CMD_write (PA6) may be performed in the nonvolatile memory device 200. Specifically, data may be stored in the page PG6 of the memory block Blk0.

In an embodiment, when it is determined that the third condition is satisfied (YES at step S7000), i.e., the number of memory blocks having no data stored therein among the memory blocks Blk0 to Blk7 is greater than or equal to the set or preset block number, at step S7200, the controller 100 may allocate the second memory block, i.e., the memory block Blk1 as a new open block, and set the memory block Blk0 to a closed block. For example, when the set or preset block number is 5 and the number of memory blocks having no data stored therein is 6 as illustrated in FIG. 5C, the controller 100 may determine that the third condition is satisfied. Then, at step S7300, the controller 100 may generate a write command CMD_write (PA8) for the target data and transfer the generated write command CMD write (PA8) to the nonvolatile memory device 200. The write command CMD_write (PA8) includes the physical address PA8 corresponding to a page to store data among the pages PG0 to PG7 of the second memory block set to the new open block, i.e., the memory block Blk1. At step S7400, the target data corresponding to the logical address LA512 may be stored in an area corresponding to a physical address PA8 of the nonvolatile memory device 200, i.e., a page corresponding to a block offset OFS_Blk of 1 and a page offset OFS_PG of 0.

As a result, the data corresponding to the logical addresses LA0 to LA5 may be stored in the pages PG0 to PG5 corresponding to the physical addresses PA0 to PA5 in the memory block Blk0, and the pages corresponding to the physical addresses PA6 and PA7, i.e., the pages PG6 and PG7 of the memory block Blk0 corresponding to the page offsets OFS_PG of 6 and 7 may be set to a closed block with no data stored therein.

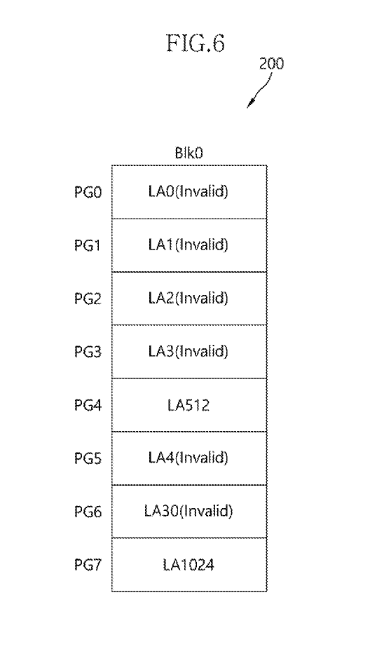

FIG. 6 illustrates an example in which garbage collection is performed after data having non-consecutive logical addresses are stored in the same memory block. Concerns which occur when data having non-consecutive logical addresses are stored in the same memory block will be described with reference to FIGS. 1 and 6.

In the illustration of FIG. 6, data corresponding to logical addresses LA0, LA1, LA2, LA3, LA512, LA4, LA30 and LA1024 were stored in the pages PG0 to PG7 in the memory block Blk0, respectively. That is, data having consecutive logical addresses were stored in the pages PG0 to PG3 corresponding to the page offsets OFS_PG of 0 to 3 among the pages PG0 to PG7 in the memory block Blk0 having the block offset OFS_Blk of 0, and data having non-consecutive logical addresses with respect to pages having adjacent offsets were stored in the pages PG3 to PG7 corresponding to the page offsets OFS_PG of 3 to 7.

When data having non-consecutive logical addresses are stored in the same memory block, it is highly likely that much valid data are present during garbage collection. Specifically, since data having consecutive logical addresses are highly likely to be updated at the same time, the data are highly likely to become invalid data at the same time. In contrast, since data having non-consecutive logical addresses are highly likely to be independently updated, the data are highly likely to become invalid at different times.

As illustrated in FIG. 6, the data corresponding to the logical addresses LA0 to LA4 and the data corresponding to the logical address LA30 may be updated. That is, valid data may be stored in a memory block other than the memory block Blk0. In this case, when garbage collection is performed on the memory block Blk0, the following operations may be performed. Valid data corresponding to the logical address LA512 may be copied, the mapping table 121 in which the mapping information on the logical address LA512 is stored may be read, the mapping information on the logical address LA512 may be changed, and the data corresponding to the logical address LA512 may be stored in a new memory block. Similarly, valid data corresponding to the logical address LA1024 may be copied, the mapping table 121 in which the mapping information on the logical address LA1024 is stored may be read, the mapping information on the logical address LA1024 may be changed, and the data corresponding to the logical address LA1024 may be stored in a new memory block. Then, all of the data stored in the memory block Blk0 corresponding to the target of the garbage collection may be erased.

When the data having non-consecutive logical addresses are stored in the same memory block, it is highly likely that much valid data are present during garbage collection. Therefore, copy operations and map update operations for a plurality of data may be accompanied, which makes it difficult to perform the operation efficiently.

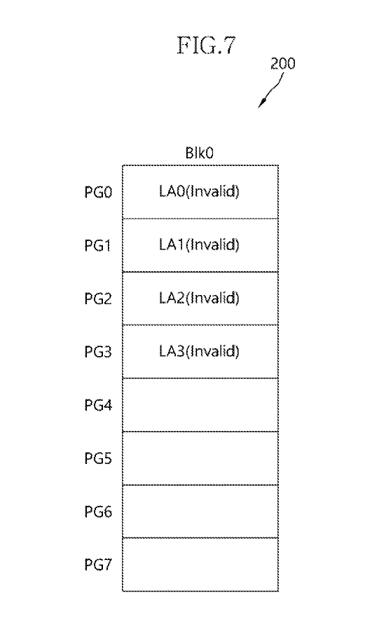

FIG. 7 illustrates an example in which garbage collection is performed after data having non-consecutive logical addresses are stored in different memory blocks, in accordance with an embodiment of the present invention. The garbage collection operation in the case where data having non-consecutive logical addresses are stored in different memory blocks will be described with reference to FIGS. 1 to 7.

In the illustration of FIG. 7, data corresponding to the logical addresses LA0 to LA3 were stored in the pages PG0 to PG3 in the memory block Blk0, respectively. That is, data having consecutive logical addresses were stored in the pages PG0 to PG3 corresponding to the page offsets OFS_PG of 0 to 3 among the pages PG0 to PG7 in the memory block having the block offset OFS_Blk of 0, and the other pages PG4 to PG7 were set to a closed block with no data stored therein.

In an embodiment, the first memory block corresponding to an open block may be set to a closed block when the first condition is satisfied, and only data corresponding to consecutive logical addresses may be stored in the first memory block when the second memory block is set to a new open block. Then, the first memory block, i.e., the memory block Blk0 may be selected as a victim block of a garbage collection operation. When the garbage collection operation is performed, a data copy operation does not need to be performed, but the garbage collection operation may be completed through a process of easing the data stored in the memory block Blk0 and performing an update operation for the mapping table 121 including information on the logical addresses LA0 to LA3.

In another embodiment, when the first and second conditions are satisfied, the first memory block corresponding to an open block may be set to a closed block, and the second memory block may be set to a new open block. When the number of pages having data stored therein among the pages PG0 to PG7 in the first memory block is greater than or equal to the set or preset page number, only data corresponding to consecutive logical addresses may be stored in the first memory block. The data corresponding to non-consecutive logical addresses may not be unconditionally stored in another memory block, but a write operation may be performed on another memory block only when the amount of data stored in the first memory block, i.e., the memory block Blk0 corresponds to a set or predetermined level, which makes it possible to reduce the possibility that the storage capacity of the nonvolatile memory device 200 will be wasted.

In another embodiment, when the first and third conditions are satisfied, the first memory block corresponding to an open block may be set to a closed block, and the second memory block may be set to a new open block. When the number of blocks having no data stored therein among the plurality of memory blocks Blk0 to Blk(n) in the nonvolatile memory device 200 is greater than or equal to the set or preset block number, only data corresponding to consecutive logical addresses may be stored in the first memory block. Data corresponding to non-consecutive logical addresses may not be unconditionally stored in another memory block, but a write operation may be performed on another memory block only when the number of memory blocks having no data stored therein among the memory blocks Blk0 to Blk(n) in the nonvolatile memory device 200 is greater than or equal to the set or preset block number, which makes it possible to reduce the possibility that the storage space will be used insufficiently while an open block is set to a closed block even though the number of free blocks is not insufficient.

Although not illustrated, embodiments may be configured as an electronic device including a non-transitory machine-readable storage medium having instructions stored therein.

In various embodiments, the electronic device decides a location at which to store data based on the properties of memory blocks. The electronic device may include a controller 100 and a non-transitory machine-readable storage medium including a plurality of memory blocks and configured to store encoded instructions which can be executed by the controller 100. In an embodiment, the instructions stored in the non-transitory machine-readable storage medium may include: an instruction for specifying a first memory block having target data stored therein according to a set or preset sequence, when a write request for the target data is received from the host device 300; an instruction for determining whether a first memory block satisfies a block replacement condition; and an instruction for setting the first memory block to a closed block when the first memory block satisfies the block replacement condition, and controlling a write operation to store the target data in a second memory block set to a new open block.

In an embodiment, the instruction for determining whether the block replacement condition is satisfied may include an instruction for determining whether the block replacement condition is satisfied, based on whether a first logical address group corresponding to the most recently stored data in the memory block and a second logical address group corresponding to the target data are consecutive to each other.

In an embodiment, the instruction for determining whether the block replacement condition is satisfied may include an instruction for determining that the block replacement condition is satisfied when the first logical address group and the second logical address group are not consecutive to each other, and determining that the block replacement condition is not satisfied when the first logical address group and the second logical address group are consecutive to each other.

In an embodiment, the instruction for determining whether the block replacement condition is satisfied may further include an instruction for determining whether the block replacement condition is satisfied, based on the number of pages having data stored therein among the pages included in the first memory block.

In an embodiment, the instruction for determining whether the block replacement condition is satisfied may further include an instruction for determining that the block replacement condition is satisfied, when the first logical address group and the second logical address group are not consecutive to each other and the number of pages having data stored therein is greater than or equal to the set or preset page number.

In an embodiment, the instruction for determining whether the block replacement condition is satisfied may further include an instruction for determining whether the block replacement condition is satisfied, based on the number of memory blocks having no data stored therein among the memory blocks.

In an embodiment, the instruction for determining whether the block replacement condition is satisfied may include an instruction for determining that the block replacement condition is satisfied, when the first logical address group and the second logical address group are not consecutive to each other, the number of pages having data stored therein is greater than or equal to the set or preset page number, and the number of memory blocks having no data stored therein is greater than or equal to the set or preset block number.

In various embodiments, an operating method of the memory system 10 may include: selecting a first memory block to store target data according to a set or preset sequence in response to a write request received from the host device 300; determining whether the first memory block satisfies the block replacement condition; and setting the first memory block to a closed block and storing the target data in a second memory block set to a new open block, when the block replacement condition is satisfied.

In an embodiment, the determining of whether the block replacement condition is satisfied may include: determining that a first condition is satisfied when a logical address group and a start logical address are not consecutive to each other; and determining that the first condition is not satisfied when the logical address group and the start logical address are consecutive to each other.

In an embodiment, the determining of whether the block replacement condition is satisfied may include: determining whether a second condition is satisfied when the first condition is satisfied; and determining that the block replacement condition is satisfied when the second condition is satisfied.

In an embodiment, the determining of whether the block replacement condition is satisfied may include: determining whether a third condition is satisfied when the first and second conditions are satisfied; and determining that the block replacement condition is satisfied when the third condition is satisfied.

FIG. 8 is a block diagram illustrating the controller 100 in accordance with an embodiment of the present invention.

Referring to FIGS. 1 to 8, the controller 100 may further include a host interface 130 and a memory control component 140.

The host interface 130 may interface the host device 300 and the memory system 10. For example, the host interface 130 may communication with the host device 300 using any one of standard transfer protocols, i.e., a host interface. The standard transfer protocols may include secure digital, Universal Serial Bus (USB), Multi-Media Card (MMC), Embedded MMC (eMMC), Personal Computer Memory Card International Association (PCMCIA), Parallel Advanced Technology Attachment (PATA), Serial Advanced Technology Attachment (SATA), Small Computer System Interface (SCSI), Serial Attached SCSI (SAS), Peripheral Component Interconnection (PCI), PCI Express (PCI-e or PCIe) and Universal Flash Storage (UFS).

The memory control component 140 may control a storage medium according to control of the control component 110. The memory control component 140 may also be referred to as a memory interface. The memory control component 140 may provide control signals to the nonvolatile memory device 200 of FIG. 1. The control signals may include a command, address and control signal for controlling the nonvolatile memory device 200. The memory control component 140 may provide data to the nonvolatile memory device 200, or receive data from the nonvolatile memory device 200.

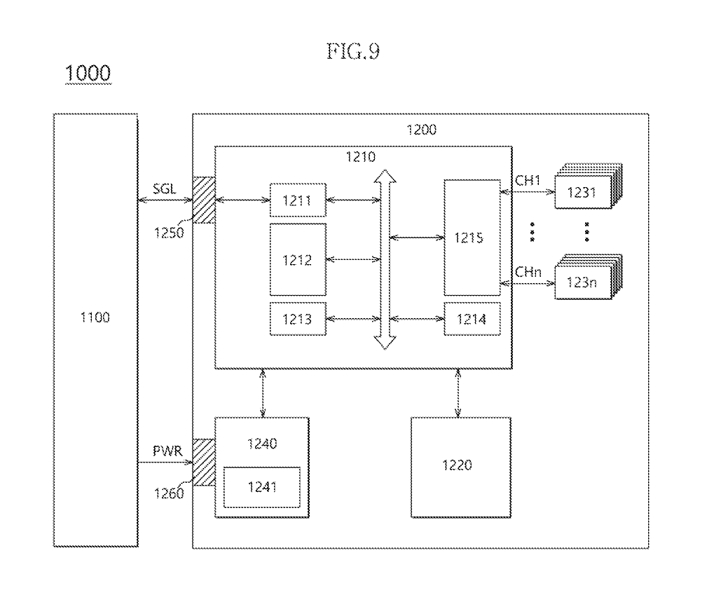

FIG. 9 is a diagram illustrating a data processing system 1000 including a solid state drive (SSD) 1200 in accordance with an embodiment. Referring to FIG. 9, the data processing system 1000 may include a host device 1100 and the SSD 1200.

The SSD 1200 may include a controller 1210, a buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and so forth. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The control component 1212 may analyze and process a signal SGL inputted from the host device 1100. The control component 1212 may control operations of internal function blocks according to firmware or software for driving the SSD 1200. The random access memory 1213 may be used as a working memory for driving such firmware or software.

The error correction code (ECC) component 1214 may generate the parity data of data to be transmitted to the nonvolatile memory devices 1231 to 123n. The generated parity data may be stored together with the data in the nonvolatile memory devices 1231 to 123n. The error correction code (ECC) component 1214 may detect an error of the data read out from the nonvolatile memory devices 1231 to 123n, based on the parity data. If a detected error is within a correctable range, the error correction code (ECC) component 1214 may correct the detected error.

The memory interface 1215 may provide control signals such as commands and addresses to the nonvolatile memory devices 1231 to 123n, according to control of the control component 1212. Moreover, the memory interface 1215 may exchange data with the nonvolatile memory devices 1231 to 123n, according to control of the control component 1212. For example, the memory interface 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured as any of various types of connectors depending on an interface scheme between the host device 1100 and the SSD 1200.

The power connector 1260 may be configured as any of various types of connectors depending on a power supply scheme of the host device 1100.

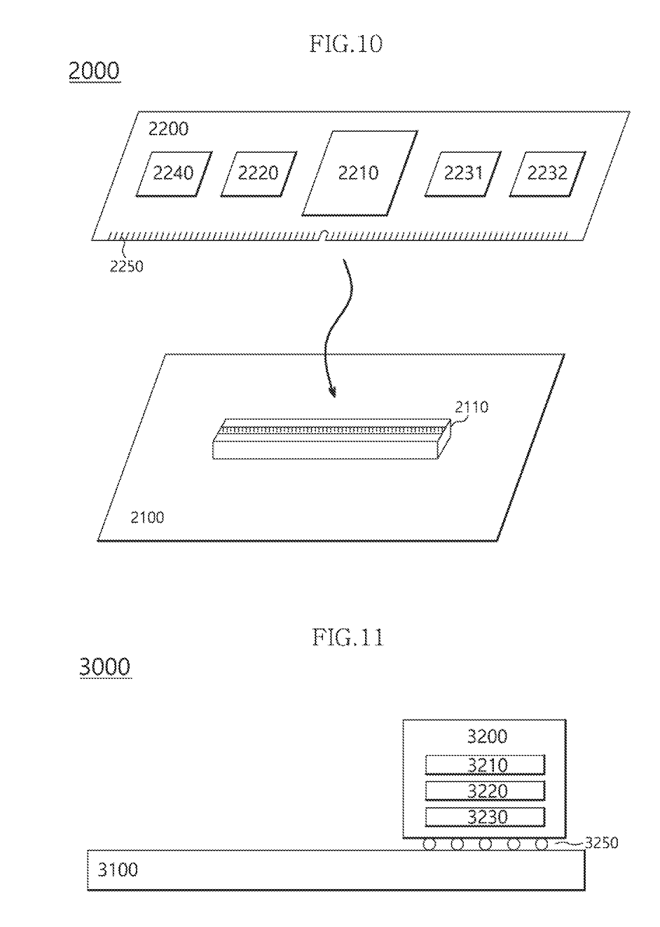

FIG. 10 is a diagram illustrating a data processing system 2000 including a data storage device 2200 in accordance with an embodiment of the present invention. Referring to FIG. 10, the data processing system 2000 may include a host device 2100 and the data storage device 2200.

The host device 2100 may be configured in the form of a board such as a printed circuit board. Although not shown, the host device 3100 may include internal function blocks for performing the function of a host device.

The host device 2100 may include a connection terminal 2110 such as a socket, a slot or a connector. The data storage device 2200 may be mounted to the connection terminal 2110.

The data storage device 2200 may be configured in the form of a board such as a printed circuit board. The data storage device 2200 may be referred to as a memory module or a memory card. The data storage device 2200 may include a controller 2210, a buffer memory device 2220, nonvolatile memory devices 2231 and 2232, a power management integrated circuit (PMIC) 2240, and a connection terminal 2250.

The controller 2210 may control general operations of the data storage device 2200. The controller 2210 may be configured in the same manner as the controller 1210 shown in FIG. 9.

The buffer memory device 2220 may temporarily store data to be stored in the nonvolatile memory devices 2231 and 2232. Further, the buffer memory device 2220 may temporarily store the data read out from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the data storage device 2200.

The PMIC 2240 may provide the power inputted through the connection terminal 2250, to the inside of the data storage device 2200. The PMIC 2240 may manage the power of the data storage device 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the data storage device 2200. The connection terminal 2250 may be configured as any of various types depending on an interface scheme between the host device 2100 and the data storage device 2200. The connection terminal 2250 may be disposed on any one side of the data storage device 2200.

FIG. 11 is a diagram illustrating a data processing system 3000 including a data storage device 3200 in accordance with an embodiment of the present invention. Referring to FIG. 11, the data processing system 3000 may include a host device 3100 and the data storage device 3200.

The host device 3100 may be configured in the form of a board such as a printed circuit board. Although not shown, the host device 3100 may include internal function blocks for performing the function of a host device.

The data storage device 3200 may be configured in the form of a surface-mounting type package. The data storage device 3200 may be mounted to the host device 3100 through solder balls 3250. The data storage device 3200 may include a controller 3210, a buffer memory device 3220, and a nonvolatile memory device 3230.

The controller 3210 may control general operations of the data storage device 3200. The controller 3210 may be configured in the same manner as the controller 1210 shown in FIG. 9.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as a storage medium of the data storage device 3200.

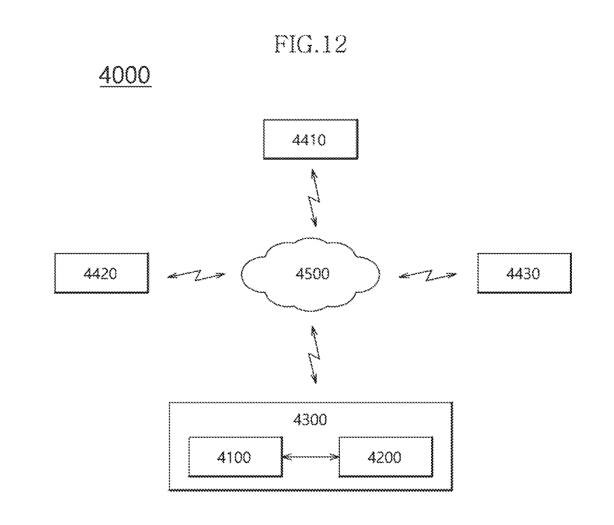

FIG. 12 is a diagram illustrating a network system 4000 including a data storage device 4200 in accordance with an embodiment of the present invention. Referring to FIG. 12, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the data storage device 4200. The data storage device 4200 may be constructed by the data storage device 10 shown in FIG. 1, the SSD 1200 shown in FIG. 9, the data storage device 2200 shown in FIG. 10 or the data storage device 3200 shown in FIG. 11.

FIG. 13 is a block diagram illustrating a nonvolatile memory device, e.g., memory device 200, included in a data storage device in accordance with an embodiment of the present invention. Referring to FIG. 13, the nonvolatile memory device 200 may include a memory cell array 210, a row decoder 220, a data read/write block 230, a column decoder 240, a voltage generator 250, and a control logic 260.

The memory cell array 210 may include memory cells MC which are arranged at areas where word lines WL1 to WLm and bit lines BL1 to BLn intersect with each other.

The row decoder 220 may be coupled with the memory cell array 210 through the word lines WL1 to WLm. The row decoder 220 may operate according to the control of the control logic 260. The row decoder 220 may decode an address provided from an external device (not shown). The row decoder 220 may select and drive the word lines WL1 to WLm, based on a decoding result. For instance, the row decoder 220 may provide a word line voltage provided from the voltage generator 250, to the word lines WL1 to WLm.

The data read/write block 230 may be coupled with the memory cell array 210 through the bit lines BL1 to BLn. The data read/write block 230 may include read/write circuits RW1 to RWn respectively corresponding to the bit lines BL1 to BLn. The data read/write block 230 may operate according to control of the control logic 260. The data read/write block 230 may operate as a write driver or a sense amplifier according to an operation mode. For example, the data read/write block 230 may operate as a write driver which stores data provided from the external device, in the memory cell array 210 in a write operation. For another example, the data read/write block 230 may operate as a sense amplifier which reads out data from the memory cell array 210 in a read operation.

The column decoder 240 may operate according to the control of the control logic 260. The column decoder 240 may decode an address provided from the external device. The column decoder 240 may couple the read/write circuits RW1 to RWn of the data read/write block 230 respectively corresponding to the bit lines BL1 to BLn with data input/output lines (or data input/output buffers), based on a decoding result.

The voltage generator 250 may generate voltages to be used in internal operations of the nonvolatile memory device 200. The voltages generated by the voltage generator 250 may be applied to the memory cells of the memory cell array 210. For example, a program voltage generated in a program operation may be applied to a word line of memory cells for which the program operation is to be performed. For still another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 260 may control general operations of the nonvolatile memory device 200, based on control signals provided from the external device. For example, the control logic 260 may control the read, write and erase operations of the nonvolatile memory device 200.

While various embodiments have been described above, it will be understood by those skilled in the art that the embodiments described may be modified in various ways. Accordingly, the present invention is not limited based on the described embodiments. Rather, the present invention encompasses all modifications that fall within the scope of the claims.

What is claimed is:

1. A memory system comprising:
a nonvolatile memory device comprising a plurality of blocks; and
a controller configured to decide a location at which to store target data corresponding to a write request received from a host device in response to the write request,
wherein, when a first memory block, of the plurality of memory blocks, to store the target data according to a set sequence satisfies a block replacement condition, the controller sets the first memory block to a closed memory block and controls the nonvolatile memory device to store the target data in a second memory block, of the plurality of memory blocks, set to a new open block.

2. The memory system according to claim 1, wherein the block replacement condition comprises a first condition, and
the first condition is satisfied when a logical address group corresponding to the most recently stored data in the first memory block and a start logical address corresponding to the target data are not consecutive to each other.

3. The memory system according to claim 2, wherein the controller controls the nonvolatile memory device to store the target data in the second memory block when the first condition is satisfied, and controls the nonvolatile memory device to store the target data in the first memory block when the first condition is not satisfied.

4. The memory system according to claim 2, wherein the block replacement condition comprises the first condition and a second condition, and
the second condition is satisfied when the number of pages having data stored therein, among pages in the first memory block is greater than or equal to a set page number.

5. The memory system according to claim 4, wherein the controller controls the nonvolatile memory device to store the target data in the second memory block when the first and second conditions are satisfied, and controls the nonvolatile memory device to store the target data in the first memory block when at least one of the first and second conditions are not satisfied.

6. The memory system according to claim 4, wherein the block replacement condition comprises the first and second conditions and a third condition, and
the third condition is satisfied when the number of memory blocks having no data stored therein, among the plurality of memory blocks, is greater than or equal to a set block number.

7. The memory system according to claim 6, wherein the controller controls the nonvolatile memory device to store the target data in the second memory block when the first to third conditions are satisfied, and controls the nonvolatile memory device to store the target data in the first memory block when at least one of the first to third conditions are not satisfied.

8. An operating method of a memory system which includes a plurality of memory blocks, the operating method comprising:
selecting a first memory block, of the plurality of memory blocks, to store target data according to a set sequence in response to a write request received from a host device;
determining, by a controller of the memory system, whether the first memory block satisfies a block replacement condition; and
setting the first memory block to a closed block, and storing the target data in a second memory block set to a new open block, when the block replacement condition is satisfied, the setting and storing operations being performed by the controller,
wherein the block replacement condition comprises a first condition, and
the first condition is whether a logical address group corresponding to the most recently stored data in the first memory block and a start logical address corresponding to the target data are consecutive to each other.

9. The operating method according to claim 8, wherein the determining of whether the block replacement condition is satisfied comprises:
determining that the first condition is satisfied, when the logical address group and the start logical address are not consecutive to each other; and
determining that the first condition is not satisfied, when the logical address group and the start logical address are consecutive to each other.

10. The operating method according to claim 9, wherein the block replacement condition comprises the first condition and a second condition, and
the second condition is satisfied when the number of pages having data stored therein among pages in the first memory block is greater than or equal to a set page number.

11. The operating method according to claim 10, wherein the determining of whether the block replacement condition is satisfied comprises:
determining whether the second condition is satisfied, when the first condition is satisfied; and
determining that the block replacement condition is satisfied, when the second condition is satisfied.

12. The operating method according to claim 11, wherein the block replacement condition comprises the first and second conditions and a third condition, and
the third condition is satisfied when the number of memory blocks having no data stored therein, among the plurality of memory blocks, is greater than or equal to a set block number.

13. The operating method according to claim 12, wherein the determining of whether the block replacement condition is satisfied comprises:
determining whether the third condition is satisfied, when the first and second conditions are satisfied; and
determining that the block replacement condition is satisfied, when the third condition is satisfied.

14. An electronic device comprising:
a controller; and
a non-transitory machine-readable storage medium comprising a plurality of memory blocks, and configured to store encoded instructions which are executed by the controller,
wherein the instructions comprise:
an instruction for specifying a first memory block, of the plurality of memory blocks, having target data stored therein according to a set sequence, when a write request for the target data is received from a host device;
an instruction for determining whether the first memory block satisfies a block replacement condition; and
an instruction for setting the first memory block to a closed block and controlling a write operation to store the target data in a second memory block set to a new open block, when the first memory block satisfies the block replacement condition.

15. The electronic device according to claim 14, wherein the instruction for determining whether the block replacement condition is satisfied comprises an instruction for determining whether the block replacement condition is satisfied based on whether a first logical address group corresponding to the most recently stored data in the first memory block and a second logical address group corresponding to the target data are consecutive to each other.

16. The electronic device according to claim 15, wherein the instruction for determining whether the block replacement condition is satisfied comprises:
an instruction for determining that the block replacement condition is satisfied, when the first logical address group and the second logical address group are not consecutive to each other; and
an instruction for determining that the block replacement condition is not satisfied, when the first logical address group and the second logical address group are consecutive to each other.

17. The electronic device according to claim 15, wherein the instruction for determining whether the block replacement condition is satisfied further comprises an instruction for determining whether the block replacement condition is satisfied based on the number of pages having data stored therein among the pages included in the first memory block.

18. The electronic device according to claim 17, wherein the instruction for determining whether the block replacement condition is satisfied comprises an instruction for determining that the block replacement condition is satisfied when the first logical address group and the second logical address group are not consecutive to each other and the number of pages having data stored therein is greater than or equal to a set page number.

19. The electronic device according to claim 17, wherein the instruction for determining whether the block replacement condition is satisfied further comprises an instruction for determining whether the block replacement condition is satisfied based on the number of memory blocks having no data stored therein among the plurality of memory blocks.

20. The electronic device according to claim 19, wherein the instruction for determining whether the block replacement condition is satisfied comprises an instruction for determining that the block replacement condition is satisfied, when the first logical address group and the second logical address group are not consecutive to each other, the number of pages having data stored therein is greater than or equal to a set page number, and the number of memory blocks having no data stored therein is greater than or equal to a set block number.
